(19) United States
(12) Patent Application Publication
(10) Pub. No.: US 2020/0290681 A1
(43) Pub. Date: Sep. 17, 2020

(54) VEHICLE BODY UPPER STRUCTURE

(71) Applicant: Mazda Motor Corporation, Hiroshima (JP)

(72) Inventors: Daisuke KIYOSHITA, Hiroshima (JP); Takeshi NAKAMURA, Hiroshima (JP)

(73) Assignee: Mazda Motor Corporation, Hiroshima (JP)

(21) Appl. No.: 16/808,399

(22) Filed: Mar. 4, 2020

(30) Foreign Application Priority Data
Mar. 14, 2019 (JP) 2019-047328

(51) Int. Cl. B62D 25/06; B62D 27/02

(52) U.S. Cl. CPC B62D 25/06; B62D 27/023

(57) ABSTRACT

A vehicle body upper structure includes a dampening material; a pair of first structures that constitute portions on both sides in a width direction of a vehicle body in an upper portion of the vehicle body; and a second structure that extends in the width direction and is joined at opposing ends to the pair of first structures so as to define at least a part of a window opening, to which a windshield is attachable in cooperation with the pair of first structures. The second structure includes a first component and a second component that is joined to the first component in a partially overlapping state therewith, wherein the first component is joined in an overlapping portion to the second component via the damping material at an end of the first component on the first structure side.

### CROSS REFERENCE TO RELATED APPLICATION

The present application contains claims priority to Japanese Priority Application 2019-047328, filed Mar. 14, 2019, the entire contents of which are incorporated herein by reference.

### TECHNICAL FIELD

The present disclosure relates to a vehicle body upper structure.

### BACKGROUND ART

In a normal vehicle, a windshield is joined to an opening that is formed in an upper front portion or an upper rear portion of a vehicle body by adhesion. In such a vehicle body upper structure, a vibration generated in a wheel or a powertrain is transmitted to the windshield via a vehicle body frame during travel of the vehicle. As a result, the windshield vibrates, and the vibration thereof is possibly transmitted as noise to the inside of a cabin.

In order to suppress transmission of the vibration to the windshield, in a vehicle body structure disclosed in Patent document 1, an adhesive having a vibration damping property is used to adhere the windshield to the vehicle body frame. The adhesive having the vibration damping property has a function of damping the vibration by converting vibration energy into thermal energy.

In a vehicle body structure disclosed in Patent document 2, a rear header member that defines a windshield opening in the vehicle body frame and a rear-pillar side block are adhered to each other by the adhesive having the vibration damping property, so as to suppress the transmission of the vibration to the windshield.

### PRIOR ART DOCUMENTS

### Patent Documents

[Patent document 1] JP-A-2010-125980

[Patent document 2] JP-A-2011-93449

### SUMMARY OF THE DISCLOSURE

### Problems to be Solved by the Disclosure

In both of the above vehicle body upper structures, the transmission of the vibration to the windshield is suppressed by using the adhesive having the vibration damping property. By the way, in order to improve steering stability of the vehicle, it is preferred to improve rigidity of the vehicle body. In the vehicle body upper structure, it is an aim to improve rigidity of a roof side rail, a front pillar, a front header, and the like. However, in the case where rigidity of components, such as the front pillar and the front header, for defining the opening, to which the windshield is joined, is improved, the components themselves are likely to function as vibration transmission paths. As a result, improvement in suppression of vibration transmission to the windshield by the adhesive becomes difficult.

The present disclosure has been made in view of the above circumstance and therefore has a purpose of providing a vehicle body upper structure capable of improving an effect of suppressing transmission of a vibration to a windshield while securing rigidity of a vehicle body.

### Means for Solving the Problem

In order to solve the above problem, a vehicle body upper structure according to the present disclosure includes: a damping material; a pair of first structures that constitute portions on both sides in a width direction of a vehicle body in an upper portion of the vehicle body; and a second structure that extends in the width direction and is joined at opposing ends to the pair of first structures so as to define at least a part of a window opening, to which a windshield is attachable in cooperation with the pair of first structures, wherein the second structure includes a first component that is joined to one structure of the pair of first structures at a first position, and a second component that extends in the width direction, and at a second position separated in distance from the first position, the second component is joined to the first component in a partially overlapping state therewith via the damping material.

In such a configuration, the second structure that defines at least the part of the window opening in cooperation with the first structures includes: the first components, each of which is joined to the respective first structures; and the second component. In each of the first components, rigidity is partially increased in the overlapping portion in which the first component overlaps and is joined to the second component. Meanwhile, in a portion in which the first component does not overlap the second component, the rigidity is relatively lower than that of the overlapping portion.

Accordingly, as described above, at the end on the first structure side in the overlapping portion with the second component, each of the first components is joined to the second component via the damping member. In this way, the portion of each of the first components that does not overlap the second component can also be joined to the second component via the damping member within a range of the overlapping portion.

In such a configuration, a vibration that is transmitted from the first structure to the second structure is first concentrated in the low-rigid portion where the first component of the second structure does not overlap the second component. Since this portion is joined to the second component by the damping member as described above, the vibration that is concentrated in this portion is effectively damped by the damping member. Meanwhile, the rigidity of the second structure can be secured by the high-rigid overlapping portion where the first component and the second component overlap and are joined to each other. As a result, it is possible to improve an effect of suppressing the transmission of the vibration to the windshield by the damping member while securing the rigidity of the vehicle body.

In the vehicle body upper structure described above, the first component is joined to the one structure of the pair of first structures by the damping material.

According to such a configuration, the low-rigid portion of the first component that does not overlap the second component is joined to the first structure and the second component via the damping members. Thus, it is possible to further effectively damp the vibration concentrated in this portion by the damping members at two positions.

In the vehicle body upper structure described above, the second component has a reinforced portion at a position removed from the overlapping portion, a rigidity of reinforced position is higher than another portion of the second component.

According to such a configuration, the reinforced portion having the high rigidity is provided at the position away from the joined portion of the second component to the first component. Thus, it is possible to improve the rigidity of not only the second component but also the entire second structure including the second component.

In the vehicle body upper structure described above, the second component is constructed of a plate-shaped structure, and the reinforced portion includes a portion of the plate-shaped structure that is deformed to extend in a plate thickness direction.

According to such a configuration, it is possible to easily form the reinforced portion by processing the plate-shaped member by pressing or the like.

### Advantage of the Disclosure

According to the vehicle body upper structure of the present disclosure, it is possible to improve the effect of suppressing the transmission of the vibration to the windshield by the damping member while securing the rigidity of the vehicle body.

According to another aspect, a vehicle body upper structure according to the present disclosure includes: a pair of first structures that constitute portions on both sides in a width direction of a vehicle body in an upper portion of the vehicle body; and a second structure that extends in the width direction and is joined at opposing ends to the pair of first structures so as to define at least a part of a window opening, to which a windshield is attachable in cooperation with the pair of first structures, wherein the second structure includes a first component that is joined to one structure of the pair of first structures at a first position, and a second component that extends in the width direction, and at a second position separated in distance from the first position, the second component is joined to the first component in a partially overlapping state therewith via the damping material.

### BRIEF DESCRIPTION OF THE DRAWINGS

FIG. 1 is an entire perspective view of a vehicle body upper structure according to an embodiment of the present disclosure.

FIG. 2 is an enlarged perspective view in which a joined portion between a front pillar and a front header illustrated in FIG. 1 and a portion around the joined portion are enlarged.

FIG. 3 is a perspective view for illustrating a state where the front header illustrated in FIG. 2 is exploded.

FIG. 4 is a cross-sectional view that is taken along line IV-IV in FIG. 2.

FIG. 5 is a perspective view for illustrating arrangement of adhesives when the front header illustrated in FIG. 2 is seen from above.

FIG. 6 is a perspective view for illustrating the arrangement of the adhesives when the front header illustrated in FIG. 2 is seen from below.

FIG. 7 is a cross-sectional view that is taken along line VII-VII in FIG. 2.

FIG. 8 is a cross-sectional view that is taken along line VIII-VIII in FIG. 2.

FIG. 9 is a plan view of an upper member in FIG. 3.

FIG. 10 is a view in which a state of combining a lower side member and a lower center member illustrated in FIG. 3 is seen from below.

### MODES FOR CARRYING OUT THE DISCLOSURE

A detailed description will hereinafter be made on a preferred embodiment of the present disclosure with reference to the accompanying drawings.

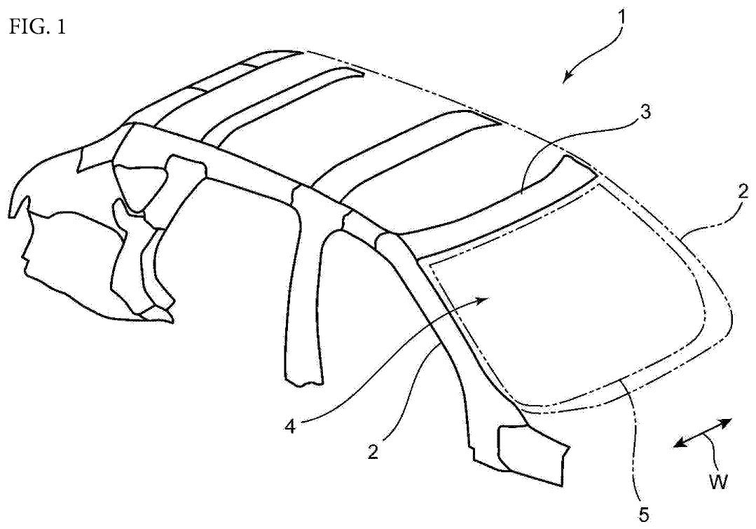

As an exemplary embodiment of the present disclosure, an upper structure of a vehicle body 1 illustrated in FIGS. 1 to 4 relates to a structure that defines a window opening 4, to which a front-side windshield 5 can be attached, and includes: a pair of front pillars 2 as a pair of first structures; a front header 3 as a second structure; damping glues 21, 23, each of which joins the front header 3 to the front pillar 2; and a damping glue 22 that joins components (a lower side member 7 and a lower center member 8), which will be described later, in the front header 3.

The damping glues 21, 22, 23 are included as damping members in the present disclosure and have a primary function of damping a vibration by converting vibration energy into thermal energy. A material and a physical property of each of the damping glues are not particularly limited in the present disclosure. As each of the damping glues 21, 22, 23, for example, a sealer or a rubber-based adhesive that is frequently used in a hemmed portion between an outer panel and an inner panel of a vehicle body is used. Such an adhesive or the like has a vibration damping characteristic when a storage modulus is equal to or lower than 500 MPa and a loss coefficient is equal to or higher than 0.2 under conditions that a temperature is 20° C. and a frequency of an excitation force is 30 Hz.

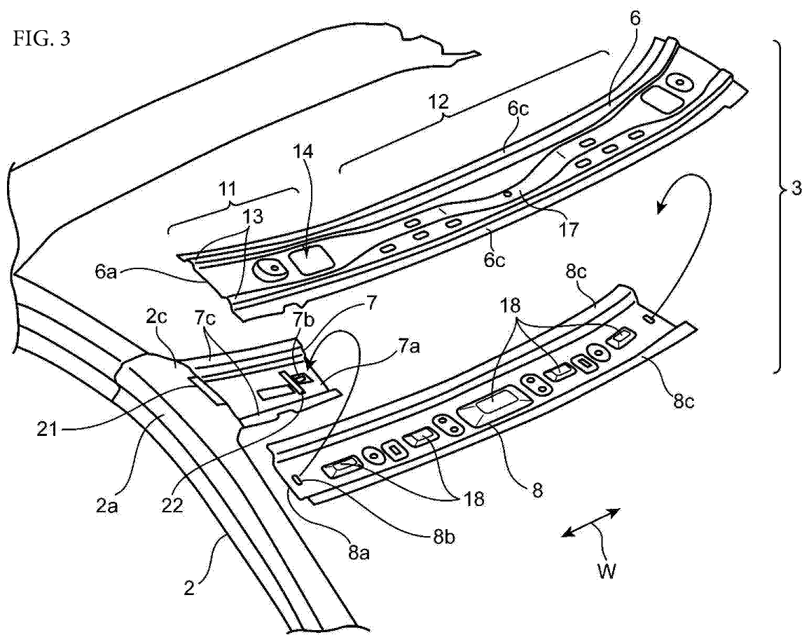

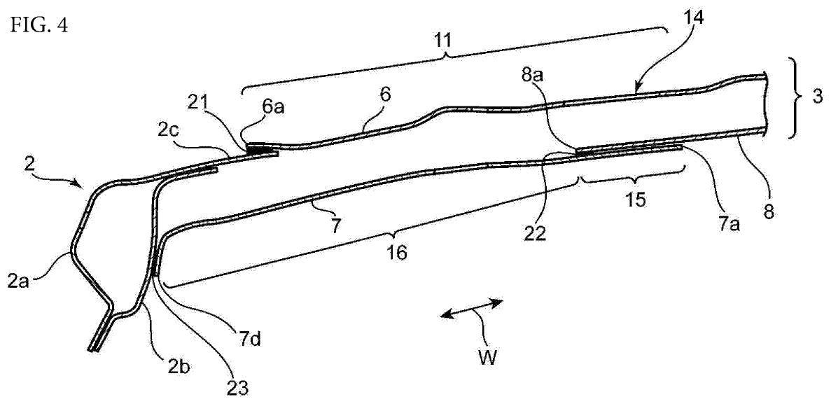

The front pillars 2 are the structures that constitute portions on both sides of the vehicle body 1 in a width direction W in an upper portion of the vehicle body 1. Each of the front pillars 2 is a long member that extends in an upward direction toward the rear of the vehicle body 1. As illustrated in FIGS. 3 to 4, each of the front pillars 2 includes: an outer member 2a that faces an outer side of the vehicle body 1; an inner member 2b that faces an inner side of the vehicle body 1; and a projected portion 2c that is projected inward in the width direction W of the vehicle body 1 from an upper end of the outer member 2a.

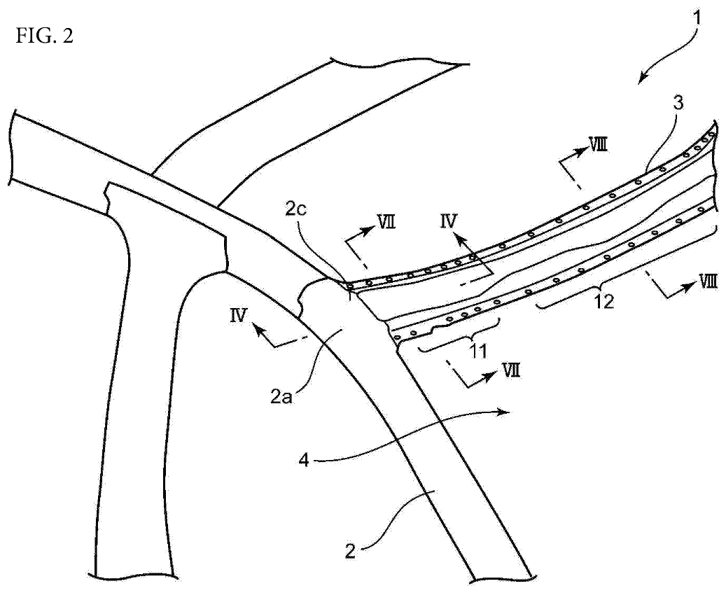

As illustrated in FIGS. 1 to 2, the front header 3 is a structure that is arranged on an upper front side of the vehicle body 1, extends in the width direction W of the vehicle body 1, and is joined to the front pillars 2 so as to define at least a part of the window opening 4, to which the front-side windshield 5 can be attached, in cooperation with the front pillars 2. The windshield 5 is joined to a portion projected inward of the window opening 4 that is formed by the front pillars 2 and the front header 3, for example, a flange 6c (see FIG. 3) of an upper member 6, which will be described later, and the like by the damping glue (not illustrated).

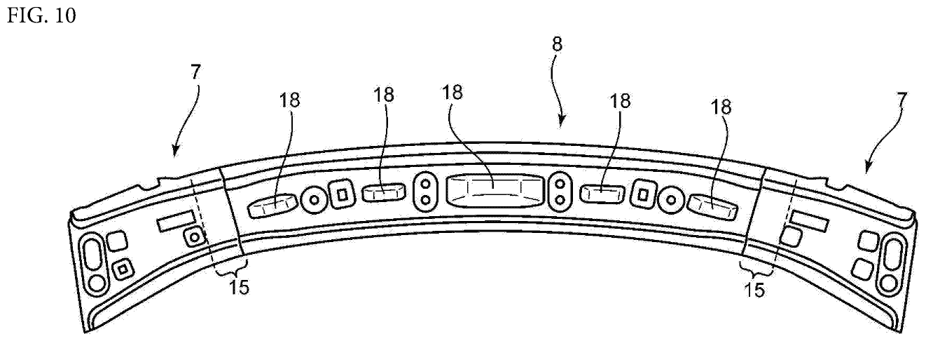

As illustrated in FIGS. 3 to 6, the front header 3 is constructed of: the upper member 6 that constitutes an upper surface of the front header 3; a pair of the lower side members 7 (see FIG. 10) as a pair of first components that constitutes portions on both sides of a lower surface of the front header 3; and the lower center member 8 as a second component that constitutes a lower central portion of the front header 3.

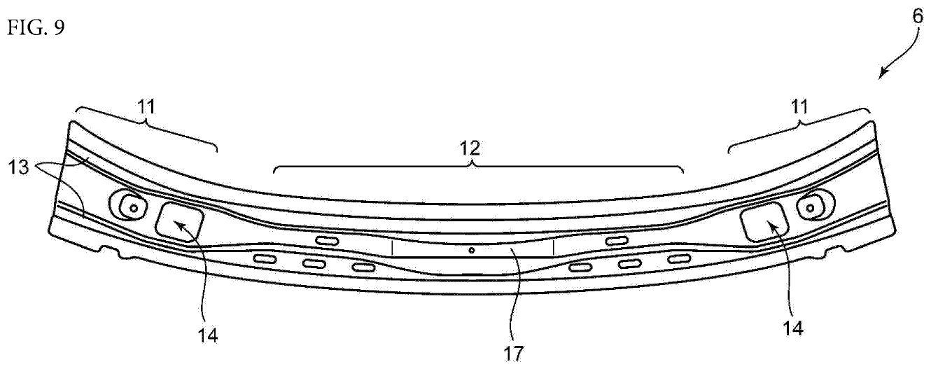

As illustrated in FIGS. 2 to 5 and FIG. 9, the upper member 6 is formed of a plate-shaped member such as a thin metal plate, and is a long member that extends to connect the front pillars 2.

Each of the lower side members 7 and the lower center member 8 is also formed of the plate-shaped member such as the thin metal plate.

In the upper structure of the vehicle body 1 in this embodiment, the upper member 6 and the front header 3 including the upper member 6 include: a low-rigid portion 11 in which a portion at an end 6a of the upper member 6 is joined to the projected portion 2c of each of the front pillars 2; and a high-rigid portion 12 that is arranged at a position away from the portion (the end 6a) where the low-rigid portion 11 is joined to the front pillar 2 and is more rigid than the low-rigid portion 11.

The upper member 6 has plural (two in this embodiment) ridgeline portions 13, each of which extends in a longitudinal direction of the front header 3 (that is, the same direction as the width direction W). Each of the ridgeline portions 13 is constructed of a projection that extends in the longitudinal direction of the front header 3. Note that the three or more ridgeline portions 13 may be provided.

As illustrated in FIG. 3 and FIGS. 7 to 8, each of the projections constituting the ridgeline portions 13 is constructed of a portion of the upper member 6 that is deformed to bend the upper member 6 upward in a plate thickness direction. Accordingly, each of the ridgeline portions 13 has a projected shape that extends in a longitudinal direction of the upper member 6.

As illustrated in FIGS. 3 to 5, the end 6a of the upper member 6 in the low-rigid portion 11 is joined to the projected portion 2c, which is projected inward in the width direction W of the vehicle body 1, in the front pillar 2 by the damping glue 21. The end 6a of the upper member 6 is further welded at welding points S to the projected portion 2c by spot welding.

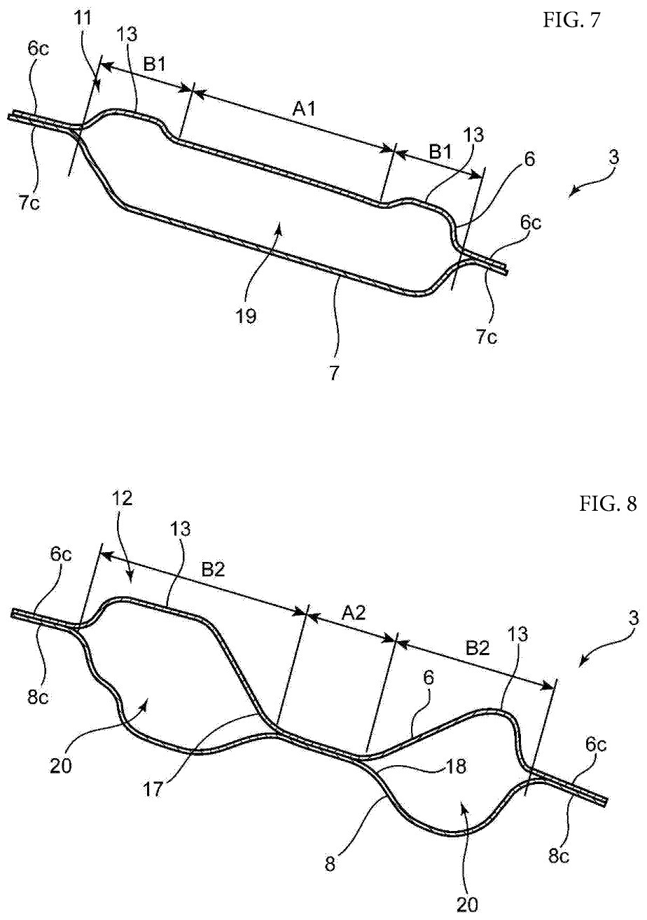

In the upper member 6, as illustrated in FIG. 2 and FIG. 7, the low-rigid portion 11 of the front header 3 has a portion formed such that a distance between the plural ridgeline portions 13 becomes a specified first distance A1.

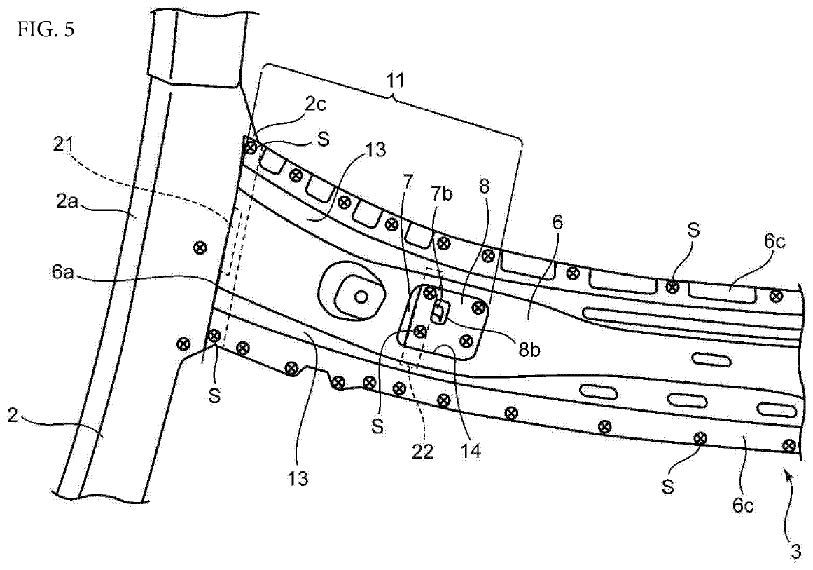

In this embodiment, as illustrated in FIG. 7, the low-rigid portion 11 of the front header 3 has a closed cross section 19 that has the longitudinal direction of the front header 3 as a normal direction. As illustrated in FIGS. 5 to 7, the closed cross section 19 is formed when the flanges 6c, 7c of the upper member 6 and the lower side member 7 constituting the front header 3 overlap each other and the flanges 6c, 7c are welded at the plural welding points S by spot welding.

Furthermore, in this embodiment, as illustrated in FIGS. 3 to 5 and FIG. 9, the low-rigid portion 11 of the upper member 6 has an opening 14 that is formed in a part of a portion constituting the closed cross section 19.

As illustrated in FIG. 2 and FIG. 8, in the upper member 6, the high-rigid portion 12 of the front header 3 has a portion formed such that the distance between the plural ridgeline portions 13 becomes a shorter second distance A2 than the first distance A1 (see FIG. 7) between the ridgeline portions 13 in the low-rigid portion 11. In addition, in this embodiment, a width B2 of each of the plural ridgeline portions 13 in the high-rigid portion 12 is greater than a width Bl (see FIG. 7) of each of the ridgeline portions 13 in the low-rigid portion 11.

The high-rigid portion 12 has plural (two in this embodiment) closed cross sections 20, each of which has the longitudinal direction as the normal direction. As illustrated in FIGS. 5 to 6 and FIG. 8, the plural closed cross sections 20 are formed when the flanges 6c, 8c of the upper member 6 and the lower center member 8 constituting the front header 3 overlap each other and the flanges 6c, 8c are welded at the plural welding points S by spot welding.

A portion between the plural closed cross sections 20 in the high-rigid portion 12 is defined when a bulged portion 18, which is formed when a portion at an intermediate position of the lower center member 8 is projected upward, and a bulged portion 17, which is formed when a portion at an intermediate position of the upper member 6 is recessed downward, abut each other. The high-rigid portion 12, which has the plural closed cross sections 20 as described above, is reinforced by the bulged portions 17, 18 forming the plural closed cross sections 20. Thus, rigidity of the high-rigid portion 12 is higher than that of the low-rigid portion 11 only having the single closed cross section 19.

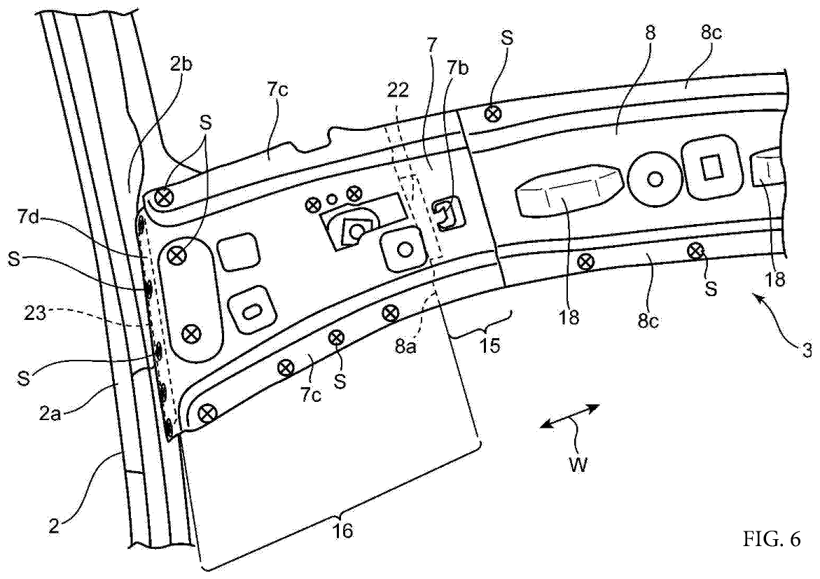

In addition, in this embodiment, as illustrated in FIG. 4 and FIG. 6, an outer end 7d of each of the lower side members 7 in the width direction W of the vehicle body 1 is joined to the respective inner members 2b of the front pillars 2 by the damping glue 23. Furthermore, the lower side member 7 is joined at the plural welding points S to the inner member 2b by spot welding.

Preferably, the lower side member 7 is brought into a joined state to the front pillar 2 in advance as illustrated in FIG. 3 by the adhesion using the damping glue 23 (see FIG. 4 and FIG. 6) and spot welding, and the lower center member 8 and the upper member 6 are thereafter joined to the lower side member 7. In this case, as illustrated in FIGS. 4 to 5, in a sub-assembly state where the lower center member 8 and the upper member 6 are combined together in advance, the lower center member 8 may be joined to the lower side member 7 by the damping glue 22 and may also be welded at the welding points S to the lower side member 7 by spot welding through the opening 14 of the upper member 6. Alternatively, even in the case where the lower center member 8 and the upper member 6 are not brought into the sub-assembly state, the lower center member 8 may be joined to the lower side member 7, and then the lower side member 8 may additionally be welded to the lower side member 7 by spot welding through the opening 14 of the upper member 6.

The lower center member 8 is a long member that extends in the width direction W of the vehicle body 1. As illustrated in FIG. 4 and FIG. 6, at a position of an overlapping portion 15 away from the portion, which is joined to the front pillar 2, in the lower side member 7 of the front header 3 (the outer end 7d in the width direction W of the lower side member 7), the lower center member 8 is joined to each of the lower side members 7 in a partially overlapping state.

More specifically, an end 8a of the lower center member 8 overlaps the end 7a of the lower side member 7 from above, and an engagement projection 7b near the end 7a is engaged with an engagement hole 8b near the end 8a. In this way, the overlapping portion 15 illustrated in FIG. 4 is formed. Then, at an end on the front pillar 2 side in the overlapping portion 15 with the lower center member 8 (more specifically, a portion near the end 8a of the lower center member 8), the lower side member 7 is joined to the lower center member 8 via the damping glue 22. Furthermore, in the overlapping portion 15, the lower center member 8 is welded at the plural welding points S to the lower side member 7 by spot welding. Spot welding between the lower side member 7 and the lower center member 8 is performed through the opening 14 of the upper member 6 illustrated in FIG. 5.

In this embodiment, as illustrated in FIG. 6 and FIG. 10, at a position away from the overlapping portion 15 in each of the ends of the lower center member 8, the lower center member 8 has the bulged portion 18 as a reinforced portion, rigidity of which is partially higher than the other portions of the lower center member 8.

The bulged portion 18 is a portion deformed to bend the plate-shaped member constituting the lower center member 8 in the plate thickness direction of the plate-shaped member (in this embodiment, in an upward direction of the lower center member 8). In this embodiment, the plural bulged portions 18 are formed along a longitudinal direction of the lower center member 8. The bulged portion 18, which is formed at the intermediate position in the longitudinal direction of the lower center member 8, is formed to have the largest projection amount.

When it is considered that the above damping glues 21, 22, 23 are used together with spot welding at the welding spots S as in this embodiment, an adhesive with a lower adhesive force than an adhesive used to join the windshield 5 to an edge of the window opening 4 may be adopted as each of the damping glues 21, 22, 23.

In the above embodiment, the description has been made on the structure of defining the window opening 4, to which the front-side windshield 5 can be attached, as the one example of the vehicle body upper structure according to the present disclosure. However, the present disclosure is not limited thereto. The vehicle body upper structure according to the present disclosure can also be applied to a structure of defining a window opening for a rear windshield or a window opening for a sunroof in a sedan or the like.

(Characteristics of this Embodiment)

(1)

The upper structure of the vehicle body 1 in this embodiment includes: the pair of the front pillars 2 as the first structures; the front header 3 as the second structure; and the damping glue 22 (see FIGS. 3 to 6) that joins the lower side members 7 (the first components) and the lower center member 8 (the second component) as the components of the front header 3.

As illustrated in FIGS. 3 to 4 and FIG. 6, each of the lower side members 7 is joined to the respective front pillars 2. The lower center member 8 extends in the width direction W of the vehicle body 1, and, at the position away from the portion (the outer end 7d in the width direction W of the lower side member 7), which is joined to the front pillar 2, is joined to each of the lower side members 7 in the partially overlapping state. At the end on the front pillar 2 side in the overlapping portion 15 with the lower center member 8 (in this embodiment, in the portion near the end 8a of the lower center member 8), the lower side member 7 is joined to the lower center member 8 via the damping glue 22.

In this configuration, the front header 3, which defines at least the part of the window opening 4 in cooperation with the pair of the front pillars 2, includes: the pair of the lower side members 7 joined to the pair of the front pillars 2; and the lower center member 8. In each of the lower side members 7, the rigidity is partially increased in the overlapping portion 15 in which the lower side member 7 overlaps and is joined to the lower center member 8. Meanwhile, in a portion 16 (see FIG. 4 and FIG. 6) where the lower side member 7 does not overlap the lower center member 8, the rigidity is relatively lower than that of the overlapping portion 15.

Accordingly, as described above, at the end on the front pillar 2 side in the overlapping portion 15 with the lower center member 8 (in the portion near the end 8a of the lower center member 8), the lower side member 7 is joined to the lower center member 8 via the damping glue 22. In this way, the portion 16, which does not overlap the lower center member 8, in the lower side member 7 can also be joined to the lower center member 8 via the damping glue 22 within a range of the overlapping portion 15.

In such a configuration, the vibration transmitted from the front pillar 2 to the front header 3 is first concentrated in the low-rigid portion 16 (see FIG. 4 and FIG. 6), which does not overlap the lower center member 8, in the lower side member 7 of the front header 3. This low-rigid portion 16 is joined to the lower center member 8 by the damping glue 22 as described above. Thus, the vibration that is concentrated in this low-rigid portion 16 is effectively damped by the damping glue 22. Meanwhile, the rigidity of the front header 3 can be secured by the high-rigid overlapping portion 15 where the lower side member 7 overlaps and is joined to the lower center member 8. As a result, it is possible to improve the effect of suppressing the transmission of the vibration to the windshield 5 by the damping glues 22 while securing the rigidity of the vehicle body 1.

(2)

In the upper structure of the vehicle body 1 in this embodiment, the outer end 7d in the width direction W of the lower side member 7 is joined to the front pillar 2 by the damping glue 23.

In this configuration, the low rigid portion 16, which does not overlap the lower center member 8, in the lower side member 7 is joined to the front pillar 2 and the lower center member 8 via the damping glues 22, 23, respectively. Thus, it is possible to further effectively damp the vibrations concentrated in this portion by the damping glues 22, 23 at the two positions.

(3)

In the upper structure of the vehicle body 1 in this embodiment, as illustrated in FIG. 6 and FIG. 10, at the position away from the overlapping portion 15, the lower center member 8 has the bulged portion 18 as the reinforced portion, the rigidity of which is partially higher than the other portions of the lower center member 8.

In this configuration, in the lower center member 8, the bulged portion 18 as the reinforced portion having the high rigidity is provided at the position away from the joined portion (the overlapping portion 15) to the lower side member 7. Thus, it is possible to improve the rigidity of not only the lower center member 8 but also the entire front header 3 including the lower center member 8.

(4)

In the upper structure of the vehicle body 1 in this embodiment, the lower center member 8 is constructed of the plate-shaped member. The bulged portion 18 as the reinforced portion is the portion that is deformed to bend the plate-shaped member in the plate thickness direction of the plate-shaped member. In this configuration, it is possible to easily form the bulged portion 18 as the reinforced portion in the lower center member 8 by processing the plate-shaped member by pressing or the like.

(5)

The upper structure of the vehicle body 1 in this embodiment includes: the pair of the front pillars 2 as the first structures; the front header 3 as the second structure; and the damping glues 21, 23 (see FIGS. 3 to 6) that join the front header 3 to the front pillars 2.

The front header 3 includes: the low-rigid portion 11 that is joined to the projected portion 2c of each of the front pillars 2; and the high-rigid portion 12 that is arranged at the position away from the portions (the ends 6a, 7a) where the low-rigid portion 11 is joined to the front pillar 2 and is more rigid than the low-rigid portion 11.

As illustrated in FIG. 4, the low-rigid portion 11 in this embodiment is joined to the front pillar 2 by the damping glues 21, 23.

In such a configuration, the upper member 6 and the front header 3 including the upper member 6, which define at least the part of the window opening 4 in cooperation with the front pillars 2, include the low-rigid portions 11 (see FIGS. 2 to 6, FIG. 7, and FIG. 9), each of which is joined to the front pillar 2. Accordingly, the vibration that is transmitted from the front pillar 2 to the front header 3 is first input to the low-rigid portion 11 of the front header 3 from both of the upper member 6 and the lower side member 7 of the front header 3, and the vibration is concentrated in the low-rigid portion 11. The low-rigid portion 11 of the front header 3 in this embodiment is joined to the front pillar 2 by the damping glue 21 between the upper member 6 and the projected portion 2c of the front pillar 2 and the damping glue 23 between the lower side member 7 and the inner member 2b of the front pillar 2. Thus, the vibration that is concentrated on the low-rigid portion 11 is effectively damped by the damping glues 21, 23. Meanwhile, in the upper member 6 and the front header 3 including the upper member 6, the high-rigid portion 12 is arranged at the position away from the portion (the ends 6a, 7d) where the low-rigid portion 11 is joined to the front pillar 2. Thus, it is possible to secure the rigidity of the front header 3. As a result, it is possible to improve the effect of suppressing the transmission of the vibration to the windshield 5 by the damping glues 21, 23 while securing the rigidity of the vehicle body 1.

(6)

In the upper structure of the vehicle body 1 in this embodiment, as illustrated in FIG. 3, FIG. 5, and FIGS. 7 to 9, the front header 3 has the plural ridgeline portions 13, each of which extends in the longitudinal direction of the front header 3, in the upper member 6. The low-rigid portion 11 has the portion formed such that the distance between the plural ridgeline portions 13 becomes the specified first distance A1. The high-rigid portion 12 has the portion formed such that the distance between the plural ridgeline portions 13 becomes the shorter second distance A2 than the first distance A1.

In this configuration, the low-rigid portion 11 and the high-rigid portion 12 can easily be formed in the front header 3 by simply changing the distance A1 between the ridgeline portions 13 illustrated in FIG. 7 is changed to the distance A2 between the ridgeline portions 13 illustrated in FIG. 8. In addition, the front header 3 can easily be designed such that the low-rigid portion 11 and the high-rigid portion 12 each has the desired rigidity.

In this embodiment, the width B2 between the plural ridgeline portions 13 in the high-rigid portion 12 is greater than the width B1 (see FIG. 7) between the ridgeline portions 13 in the low-rigid portion 11. Thus, each of the ridgeline portions 13 in the high-rigid portion 12 has the improved rigidity when compared to the ridgeline portions 13 in the low-rigid portion 11. As a result, the rigidity of the high-rigid portion 12 is further improved.

(7)

In the upper structure of the vehicle body 1 in this embodiment, each of the ridgeline portions 13 is constructed of the projection that extends in the longitudinal direction of the front header 3. Accordingly, each of the ridgeline portions 13 can be constructed by forming the projection, which extends in the longitudinal direction of the front header 3, in the upper member 6 of the front header 3. Thus, the ridgeline portions 13 can easily be designed and processed.

(8)

In the upper structure of the vehicle body 1 in this embodiment, the front header 3 has the upper member 6 that is constructed of the plate-shaped member extending to connect the front pillars 2. Each of the projections constituting the ridgeline portions 13 is the portion that is deformed to bend the upper member 6 in the plate thickness direction.

In this configuration, it is possible to easily form the projection constituting the ridgeline portion 13 by processing the upper member 6, which is formed of the plate-shaped member such as the thin metal plate, by pressing or the like.

(9)

In the upper structure of the vehicle body 1 in this embodiment, the high-rigid portion 12 has the bulged portion 17 that is formed when the upper member 6 formed of the plate-shaped member is recessed downward. Accordingly, it is possible to improve the rigidity while suppressing the upward projection of the high-rigid portion 12 and the front header 3 (particularly, the upper member 6) including the high-rigid portion 12.

(10)

In the upper structure of the vehicle body 1 in this embodiment, the low-rigid portion 11 illustrated in FIG. 7 has the closed cross section 19 that has the longitudinal direction of the front header 3 as the normal direction. The high-rigid portion 12 illustrated in FIG. 8 has the plural (two) closed cross sections 20, each of which has the longitudinal direction of the high-rigid portion 12 as the normal direction.

In this configuration, the low-rigid portion 11 and the high-rigid portion 12 can be constructed by changing the number of the closed cross sections 19, 20. Thus, it is unnecessary to significantly change outer dimensions of each of the closed cross sections 19, 20 in the low-rigid portion 11 and the high-rigid portion 12. As a result, it is possible to reduce an influence on shapes and arrangement of components (a roof panel and the like) of the vehicle body 1 that are arranged around the front header 3.

Note that, although the high-rigid portion 12 illustrated in FIG. 8 has the two closed cross sections 20, the present disclosure is not limited thereto, and the high-rigid portion 12 may have the three or more closed cross sections.

(11)

In the upper structure of the vehicle body 1 in this embodiment, the low-rigid portion 11 illustrated in FIGS. 3 to 5 and FIG. 9 has the opening 14 that is formed in the part of the portion constituting the closed cross section 19. When the opening 14 is formed in the part of the closed cross section 19 in the low-rigid portion 11, just as described, it is possible to further reduce the rigidity of the low-rigid portion 11. In this way, the vibration can further be concentrated in the low-rigid portion 11, and it is possible to further improve the effect of suppressing the transmission of the vibration to the windshield 5 by the damping glues 21, 23 (particularly, the damping glue 21 on the upper member 6 side).

### DESCRIPTION OF REFERENCE SIGNS AND NUMERALS

1: Vehicle body

2: Front pillar (first structure)

3: Front header (second structure)

4: Window opening

5: Windshield

6: Upper member

7: Lower side member (first component)

8: Lower center member (second component)

11: Low-rigid portion

12: High-rigid portion

13: Ridgeline portion

14: Opening

15: Overlapping portion

16: Non-overlapping portion

17, 18: Bulged portion

19, 20: Closed cross section

21, 22, 23: Damping glue

1. A vehicle body upper structure comprising:
a damping material;
a pair of first structures that constitute portions on both sides in a width direction of a vehicle body in an upper portion of the vehicle body; and
a second structure that extends in the width direction and is joined at opposing ends to the pair of first structures so as to define at least a part of a window opening, to which a windshield is attachable in cooperation with the pair of first structures, wherein
the second structure includes
a first component that is joined to one structure of the pair of first structures at a first position, and
a second component that extends in the width direction, and at a second position separated in distance from the first position, the second component is joined to the first component in a partially overlapping state therewith via the damping material.

2. The vehicle body upper structure according to claim 1, wherein
the first component is joined to the one structure of the pair of first structures by the damping material.

3. The vehicle body upper structure according to claim 1, wherein
the second component has a reinforced portion at a position removed from the overlapping portion, a rigidity of reinforced position is higher than another portion of the second component.

4. The vehicle body upper structure according to claim 2, wherein
the second component has a reinforced portion at a position removed from the overlapping portion, a rigidity of reinforced position is higher than another portion of the second component.

5. The vehicle body upper structure according to claim 3, wherein
the second component is constructed of a plate-shaped structure, and
the reinforced portion includes a portion of the plate-shaped structure that is deformed to extend in a plate thickness direction.

6. The vehicle body upper structure according to claim 4, wherein
the second component is constructed of a plate-shaped structure, and
the reinforced portion includes a portion of the plate-shaped structure that is deformed to extend in a plate thickness direction.

7. The vehicle body upper structure according to claim 1, wherein
the second structure further comprising another first component that is joined to another first structure of the pair of first structures.

8. The vehicle body upper structure according to claim 2, wherein
the second structure further comprising another first component that is joined to another first structure of the pair of first structures.

9. The vehicle body upper structure according to claim 3, wherein
the second structure further comprising another first component that is joined to another first structure of the pair of first structures.

10. The vehicle body upper structure according to claim 5, wherein
the second structure further comprising another first component that is joined to another first structure of the pair of first structures.

11. A vehicle body upper structure comprising:
a pair of first structures that constitute portions on both sides in a width direction of a vehicle body in an upper portion of the vehicle body; and
a second structure that extends in the width direction and is joined at opposing ends to the pair of first structures so as to define at least a part of a window opening, to which a windshield is attachable in cooperation with the pair of first structures, wherein
the second structure includes
a first component that is joined to one structure of the pair of first structures at a first position, and
a second component that extends in the width direction, and at a second position separated in distance from the first position, the second component is joined to the first component in a partially overlapping state therewith via the damping material.

12. The vehicle body upper structure according to claim 11, wherein
the first component is joined to the one structure of the pair of first structures by the damping material.

13. The vehicle body upper structure according to claim 11, wherein
the second component has a reinforced portion at a position removed from the overlapping portion, a rigidity of reinforced position is higher than another portion of the second component.

14. The vehicle body upper structure according to claim 12, wherein
the second component has a reinforced portion at a position removed from the overlapping portion, a rigidity of reinforced position is higher than another portion of the second component.

15. The vehicle body upper structure according to claim 13, wherein
the second component is constructed of a plate-shaped structure, and
the reinforced portion includes a portion of the plate-shaped structure that is deformed to extend in a plate thickness direction.

16. The vehicle body upper structure according to claim 14, wherein
the second component is constructed of a plate-shaped structure, and
the reinforced portion includes a portion of the plate-shaped structure that is deformed to extend in a plate thickness direction.

17. The vehicle body upper structure according to claim 11, wherein
the second structure further comprising another first component that is joined to another first structure of the pair of first structures.

18. The vehicle body upper structure according to claim 12, wherein
the second structure further comprising another first component that is joined to another first structure of the pair of first structures.

19. The vehicle body upper structure according to claim 13, wherein
the second structure further comprising another first component that is joined to another first structure of the pair of first structures.

20. The vehicle body upper structure according to claim 15, wherein
the second structure further comprising another first component that is joined to another first structure of the pair of first structures.
